(19) United States
(12) Patent Application Publication
(10) Pub. No.: US 2007/0288056 A1
(43) Pub. Date: Dec. 13, 2007

(54) Mitten teether/pacifier

(76) Inventor: Herbert Goldwire, Margate, FL (US)

Correspondence Address: Herbert Goldwire, 2805 N.W. 70th Ave, Margate, FL, 33063, US

(21) Appl. No.: 11/450,515

(22) Filed: Jun. 10, 2006

(51) Int. Cl. A61J 17/00

(52) U.S. Cl. 606/235

(57) ABSTRACT

This invention will be a mitt worn on a hand or hands to help easily facilitate the teething process for infants and small children. Mitten Teether/Pacifier is a soothing teether that a caregiver would not have to hold for the child. Because the mitten would be worn on the child's hand, it would be continuously available. The Mitten Teether/Pacifier may be made in various colors, shapes, fabrics, materials and sizes. The mitt will consist of a section for the palm of the hand, a section for the fingers, and compartment for either side of a central axis of the mitt for a thumb may or may not be used. Moreover, this mitt will incorporate an attached piece of soft plastic, rubber, cushion or the like may be placed on any suitable surface of the mitt. The teething part may be designed with a pacifier nipple on the opposite end.

### BACKGROUND OF THE INVENTION

1. Field of the Invention

The present invention as it relates generally to a mitt worn on a hand for infant teething. The mitt may or many not have a compartment for a thumb on either side of a central axis of the mitt, allowing the teething mitten to be worn on either hand.

2. Description of the Related or Prior Art

Current Mitts have not been used exclusively for infant teething. In addition, current teething toys are very difficult to use because the infants grasp is not fully developed yet. However, Mitten Teether solves this current problem by allowing the infant to teeth with ease. How? The Mitten Teether can be easily secured to the hand by using elastic, Velcro, ties, or a strap. Current teethers are heavy weight toys. Mitten Teether prevent teething toys from falling on the ground. This would prevent the spread of potentially harmful bacteria to infants. It is important to remember that infants do not have fully developed immune systems; therefore, efforts should be taken to prevent the spread of potentially harmful microorganisms.

3. Advantages of the Invention
a. Mitten Teether facilitates an easy teething process for infants and small children.
b. Mitten Teether reduces the risk of transmitting germs to infants and small children by allowing the teething component to be continuously attached to the hand without falling to the ground like traditional teethers.
c. Mitten Teether has a safe design and lessen discomfort associated with teething.
d. Mitten Teether prevents infants from scratching their face with their fingernails.
e. The Mitten Teether in the form of a mitten would be especially appealing to parents of babies who teeth early, before they have developed the fine motor skills necessary to manipulate a larger teething ring or toy.
f. Mitten Teether would be easier for the baby to hold in his or her mouth without constant assistance from a parent or another care provider.
g. Caregiver would also avoid the hassle of retrieving and washing teethers that have been dropped on the floor.
h. Mitten Teether can be machine washable and tumble dried unlike some of the other traditional teethers.
i. Mitten Teether would also allow infants with disabilities to teeth.

4. Disadvantages of Prior Art
a. Previous teethers do not allow infants to teeth without holding the teether by hand.
b. Previous teethers do not allow children with disable grasp of fingers to use teethers.
c. Previous teethers are not continuously available for use by the infant.
d. Previous teethers a have not been designed in a way the keeps infants from scratching the face.
e. Current teethers fall to the ground often.
f. Current teether have not been designed to reduce the risk of transmission of germs.
g. Current teethers do not keep infants hand warm while teething.
h. Current teether are too heavy for infants to hold.

### SUMMARY OF THE INVENTION

The present invention addresses the foregoing needs in the art by providing a mitt for teething or a mitt on which teething components can be attached exclusively for teething or pacifying. I came up with the idea when my newborn could not use the traditional teething methods. My baby boy would always drop the traditional teethers to the ground and experience frequent colds. However, after I developed Mitten Teether my son could finally teeth easier without dropping the teether. He also experienced less colds and respiratory infections. Because I am a registered nurse, I noticed the beneficial results of using Mitten Teether right away.

The Mitten Teether is a mitt for teething, comprising: an opening for inserting a hand; an area for a palm of the hand; an area for fingers; and a compartment for a thumb on either side of a central axis of the mitt, wherein the mitt may be used on either a right or left hand.

The teething portion will incorporate an attached piece of soft plastic, rubber, cushion or the like may be positioned at the top, right side, left side, anterior surface of the mitt, posterior surface of the mitt, wrist area of the mitt, inferior aspect of the mitt, and finally any superior aspect of the mitt can be used as a teether or where a teether can be placed.

The teething components may be various shapes, colors, and sizes. In another aspect, the present invention includes many good features. For example, infants would teeth easier. Moreover, infants would experience less contact with potentially harmful bacteria. My mitten design would allow either the entire hand to fit into the mitt or allow four fingers to fit into the mitt with the thumb in its own thumb compartment. In addition, my design would be weigh less than traditional teethers.

A better understanding of these and other objects, features, and advantages of the present invention may be had by reference to the drawings and to the accompanying description, in which there are illustrated and described preferred embodiments of the invention.

### BRIEF DESCRIPTION OF THE DRAWINGS

FIG. 1 is the front view thereof;

FIG. 2 is a side view thereof;

FIG. 3 is a top view thereof;

FIG. 4 is a bottom view thereof;

FIG. 5 is a perspective view of the mitten teether shown on a reduced scale in condition of use with any infant that is shown in broken lines for illustrative purposes only and forming no part of the claimed design. Throughout the figure, like or similar reference numerals will be used for corresponding parts.

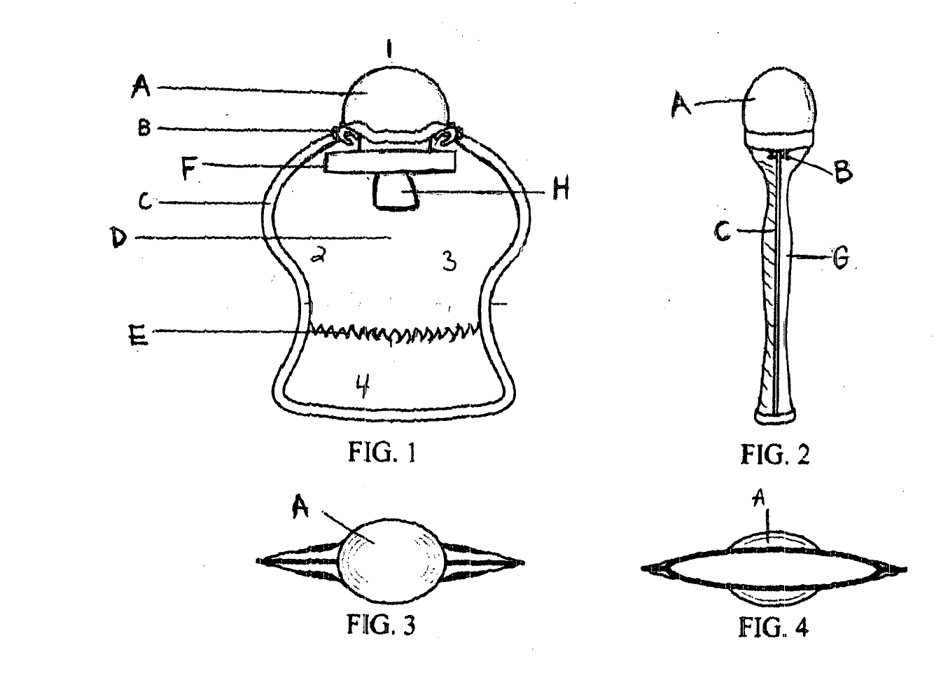

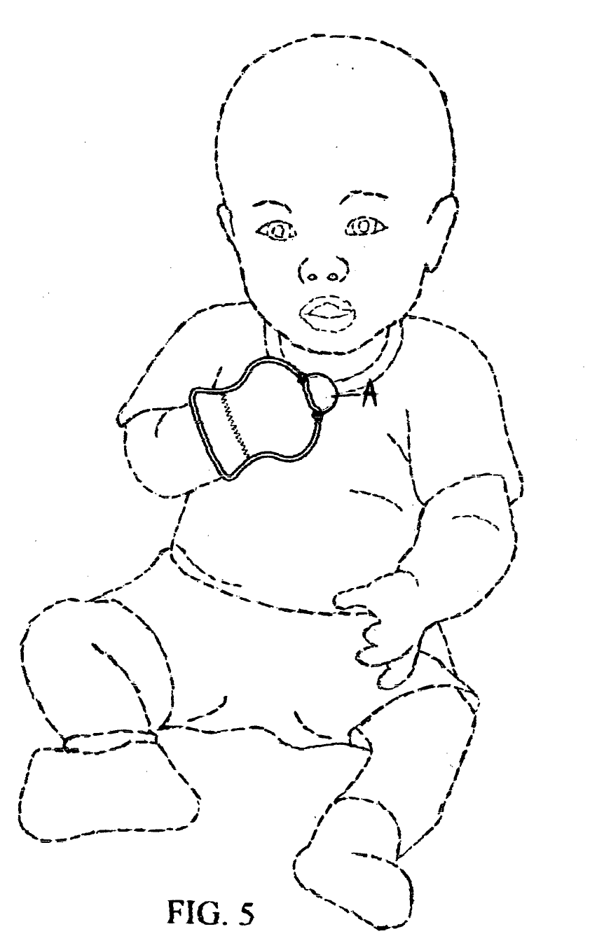

Note: In FIG. 1. letters F and H will be inside mitt for infant to hold. Mitts Outside appearance will generally look as shown in FIG. 5. However, my Invention will not be limited to this design only.

### DESCRIPTION OF PREFERRED EMBODIMENTS

For illustrative purposes, the preferred embodiments of a mitt for teething or a mitt on which teething devices can be placed as shown in FIG. 1 through FIG. 5. This invention is used for teething/pacifying infants and children.

The teething component may be made from rubber, plastic, cushion or the like. Any suitable none toxic material may be used as a tether.

In FIG. 1 through FIG. 5, it is important to note that the teether component may be any size, shape, color, or style. Furthermore, the teething component as shown in FIGS. 1,2,3,4, and 5 letter A. Moreover, the teether may also be place to right side of the mitt FIG. 1. number 2, may be place to the left side of the mitt FIG. 1 number 3, and may be placed on the wrist area of the mitt FIG. 1 number 4. In addition, the teething component may be place on any anterior surface of the mitt shown in FIG. 2 letter C representing the anterior aspect as shown by the shaded area. FIG. 2. letter G representing the posterior aspect of the mitt which is the area not shaded in with lines as shown. The Teether may also be placed at the top of the Mitt as shown in FIG. 1. number one.

According to the preferred embodiment of the present invention, the mitt will be made from any suitable teething material or fabric to be used as a teether or where a teething component can be placed.

The mitten teether will be constructed using fabric of choice and can be made in any size or shape. The mitten teether can be worn by a caregiver also if it is made large enough. Then the parent or caregiver can also help the infant or child in the teething process. However, the preferred size is for the infant or child not limiting the size of the mitt shown.

The material use for mitten teether will also prevent the infant or child from scratching the face as shown in FIG. 5.

The teething component will be attached to the mitt by standard stitching methods or any method suitable for attaching the teether to the mitt. As shown by FIG. 1. letter B. However, this invention is not limited to this design and is shown for illustration purposes only. Any suitable method can be used for attaching the teething component to the mitt.

The mitten teether will also have the potential for a unique feature. Attached to the teething component as shown in FIG. 1 letter F will be a safety bar/or surface preventing the infant from swallowing the teether. Moreover, the bar can be used to allow the infant to hold the teether from inside the mitt to allow control over teething process.

Another potential feature which may be use with mitten teether is the possibility to use the teething bar as show in FIG. 1 letter F for teething by turning the mitt inside out using the opposite side as a pacifier as shown in FIG. 1. letter H. In addition, each teething component may have a component, covering, accessory, or the like which will allow it to be detach from the mitten and reattach to the mitten using any suitable method.

The mitt shown in FIGS. 1,2,3,4, and 5 are easy to produce and cost effective. It can easily be made from two pieces of material roughly shaped like a mitten which may or may not include a space for a thumb. However the size of the material may vary depending on the size of the infant hands or if it is to be used by an adult to help the infant through the teething process. The mitt will consist of an area large enough for a hand adult size or infant size. When I refer to hand, this includes the palm, and wrist area as show in FIG. 5. See for illustration purposes how the mitt will fit on a hand. The actual size of the mitt may vary.

The mitt may also be made from disposable material.

The embodiments discussed above are representative of embodiments of the present invention and are provided for illustrative purposes only. They are not intended to limit the scope of the present invention. Although components, material, configurations, and means of connecting various parts have been shown and described, such are not limiting. Modifications and variation are contemplated within the scope of the present invention, which is intended to be limited only by the scope of the accompanying claims.

Mitten Teether could be produced easily using conventional and readily available material and manufacturing process. No new production technology would be required. The mitt will be produced from lightweight materials or other material using standard machine production techniques.

When referring to mitt in this application see FIG. 1. numbers 1,2,3, and 4. The teether is where the letter A is shown in FIGS. 1,2,34, and 5. However the teethers features, size, color, and shape is not limited by the illustrations shown. Moreover, letter E in FIG. 1 and FIG. 5 shows how the mitt will be attached to the hand. The Mitten Teether would be secured at the wrist as shown in FIG. 5. using elastic, Velcro, ties, strap, or any suitable material.

This mitt will be made using two pieces of fabric or suitable material made in the same size and shape. The two pieces of fabric or material will be sown together to form a mitt or glove. However, the material may be cut in various ways to attach a teether. This can be done using the manufactures preference to teether placement.

The teether must be sown on good enough to prevent any parts of teether from coming off.

The mitten part of the teether may show popular cartoon characters for appeal of customers or any suitable design may be used.

FIG. 1. letter H. shows how a nipple may used on the opposite end of the teether using any suitable method of attachment to inside surface. Nipple may also be used in the teethers place.

I claim:

1. A mitt for teething, comprising: an opening for inserting a hand; an area for a palm of the hand; an area for fingers; and a compartment for a thumb on either side of a central axis of the mitt, wherein the mitt may be used on either a right or left hand.
The teething portion will incorporate an attached piece of soft plastic, rubber, cushion or the like may be positioned at the top, right side, left side, anterior surface of the mitt, posterior surface of the mitt, and wrist area of the mitt, and inferior aspect of the mitt, and fully any superior aspect of the mitt can be used as a teether or where a teether can be placed.
The teething components may be various shapes, colors, and sizes.

2. The mitt according to claim 1, wherein the mitt is symmetrical about the central axis, which extends from the area for the fingers through the opening for inserting the hand allowing easy teething for infants and children.

3. The mitt according to claim 1, where in the mitt material may be any suitable fabric needed to make mitten teether.

4. The teething porting of the mitt according to claim 1, wherein the teething portion may be any suitable non toxic material for teething and promoting safe gum health.

5. The teething portion of the mitt according to claim 4, wherein the teething portion may be detachable and can also be reattached using various suitable methods.

6. The teething portion of the mitt according to claim 4, wherein the teething portion may be used on the opposite end as a teether.

7. The teething portion of the mitt according to claim 4, wherein the teething portion may be used as a protective feature preventing the infant from scratching the face.

8. The mitt according to claim 1, where in the mitt and teether component prevents the infant from biting fingers where germs are commonly located.

9. The mitt according to claim 1, where in the mitt helps reduce the risk of contracting common colds, flu, and upper respiratory tract infections.

10. The mitt according to claim 1, where in the mitt can be successfully attached to a plastic, rubber, cushion, or the like for teething purposes.

11. The teething portion of the mitt according to claim 4, where in the teething portion may be made of any lightweight suitable material.
